(19) United States
(12) Patent Application Publication
(10) Pub. No.: US 2005/0166190 A1
(43) Pub. Date: Jul. 28, 2005

(54) Method for generating an automation program

(75) Inventors: Werner Hoefler, Eckental (DE); Michael Tiegelkamp, Pyrbaum (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/933,515

(22) Filed: Sep. 3, 2004

Related U.S. Application Data
(63) Continuation of application No. PCT/DE03/00720, filed on Mar. 4, 2003.

(30) Foreign Application Priority Data
Mar. 5, 2002 (DE) 102 09 640.6

(51) Int. Cl. G06F 9/45

(52) U.S. Cl. 717/136; 717/106

(57) ABSTRACT

The invention relates to a method for generating an automation program (1) from an HMI program (3) using a generator (2). The generator (2) recognizes structures (5) of the HMI program (3) and converts them into structures (6) of the automation program (1).

The invention relates to a method for generating an automation program from an HMI program using a generator. The automation program is, for example, a program executed by a programmable logic controller. The HMI program (HMI=human machine interface) is a program used, in particular, for graphic user guidance.

Approaches to a method for automatically generating software programs have become known in connection with so-called CASE tools (CASE=Computer Aided Software Engineering) (cf., for example, Schneider, Werner: Taschenbuch der Informatik [Pocket handbook of computer science], Fachbuchverlag Leipzig, 4th edition, p. 352).

The object of the invention is to provide a method for generating an automation program used to control and/or monitor a technical process, or at least structures thereof, from an HMI program used in the same technical process.

According to the invention, this object is attained by the features of claim 1. For this purpose, a method is provided for generating an automation program to control and/or monitor a technical process from an HMI program, which is used in the same technical process, with the aid of a generator. The generator recognizes structures of the HMI program and converts them into structures of the automation program.

The invention is based on the recognition that fundamental planning data for the description of an automation project have greater similarities to user guidance by an HMI program than to a structure or algorithms of an automation program. Hence, the step from a planning view to an HMI view implemented by the HMI program is smaller than the step from the planning view to the automation program. If an HMI program is completed first, it can be used to generate an automation program. This makes it possible to significantly reduce the total implementation costs of automation solutions.

At least one automation program is required for an automation solution. Such a program evaluates sensor data of the automated technical process, performs calculations and controls actuators located in the process. An operator can use an HMI program to control and monitor the process.

Currently, a structure of the automation program is derived from a planning description (which normally includes a graphic component), and suitable control algorithms are inserted. Once the automation program has been completed, a control structure with corresponding control and monitoring elements is derived from the structure of the automation program. In other words, an algorithm view (automation program) is currently derived from a graphic view (planning). A graphic view (HMI program), in turn, is derived from the algorithm view. In the process, information from the planning view can be lost.

This process has a “historical” basis. During the first years of automation technology, an automation solution consisted almost exclusively of the control logic. Since the advent of high-performance graphics hardware, control and monitoring components have been increasingly added to automation solutions. Accordingly, for the most part, additional control and monitoring components were programmed after the automation program had been created.

The advantage of the invention is that it shortens the development time required to generate an executable automation program, since the generator automatically generates at least the fundamental structures of the automation program, into which the programmer then inserts control algorithms—possibly based on automatically inserted comment lines. This does not only save costly development time but also makes the automation programs less susceptible to systematic errors because the programmer cannot “forget” functions. They are also easier to maintain, because all automatically generated automation programs are characterized by similar structures.

The dependent claims are directed to preferred embodiments of the present invention.

In an HMI program that is based on a planning program, the generator advantageously takes into account planning data of the planning program. Thus, the structure of the automation program taken from the HMI program can be supplemented by planning data. For example, to check a limit value, the structure for taking into account an exceeded and non-exceeded limit value is generated with the aid of the HMI program and the limit value itself is taken from the planning data.

An HMI program typically includes a navigation component with a central representation and at least one subordinate representation. The generator advantageously uses the central representation to generate a main program and the one or each subordinate representation to generate a respective subroutine of the automation program.

The central representation normally includes an overall view, or an overview display, of the process to be automated. Based on this overall view, all the operable devices of the process and its components are accessible in a tree structure in the HMI program. Each representation that can be called up from the central representation is referred to as a subordinate representation. Each subordinate representation can in turn have its own subordinate representations. When converted by the generator, this structure in the HMI program is reproduced in the form of a main program that corresponds to the central representation and a subroutine that corresponds, respectively, to the one or each subordinate representation.

If each representation—regardless whether central or subordinate—includes a number of picture components and individual picture components are associated with a representation subordinate to that representation, the generator advantageously generates a call of the subroutine that corresponds to the subordinate representation for each component associated with a subordinate representation. This transfers the mutual dependence of the respective structures contained in the HMI program to the automation program.

If individual picture components are provided as input or output components for inputting or outputting data of the automated process or the process to be automated, the generator, using all the input or output components that are contained in a representation, advantageously generates a parameter list for the call of the subroutine that corresponds to the respective representation.

Furthermore, the generator advantageously expands the corresponding parameter list with respect to the input or output components that are contained in subordinate representations.

Process data that can be input or output in a representation are processed by the subroutine of the automation program corresponding to the respective representation. To use the means and the advantages of a local validity of variables to reproduce process data, these variables are transferred as parameters from the main program to the respectively called subroutine. To ensure consistency of the respectively transferred parameters, particularly type consistency, conventional programming languages provide a parameter list associated with the respective subroutine, which the generator generates automatically using the input or output components occurring in a representation. Input or output parameters that are used in a subordinate representation are already taken into account in the parameter list of the subroutine, which includes the call of the subroutine that corresponds to the subordinate representation.

Advantageously, the generator converts a process data display of the HMI program, which takes into account at least one condition, or at least one alternative, into a program sequence of the automation program for checking the condition.

Furthermore, the generator advantageously generates the program sequence for checking the condition as a component of the subroutine that corresponds to the representation containing the process data display.

To facilitate programming of the program sequence, the invention provides that the generator accepts message texts of the HMI program as comment lines in the respective program sequence to check a condition. Based on the comment lines, the programmer, who is guided by the automatically generated structures when completing the automation program, can see what actions must be taken, e.g., if a condition is satisfied, and can incorporate the corresponding instructions in the automation program.

Advantageously, the generator determines a sequence of calls of subroutines in the automation program by means of user-editable rules.

This takes into account the fact that the structure of an HMI program cannot be used directly as the structure of an automation program. Although the HMI program contains all the elements required for the automation program, it is linked according to different aspects. Especially the hierarchy of representations for the analysis of errors and the elimination of their causes resembles a network more than it does a more readily transferable tree structure, since an operator must be able to navigate easily through the entire plant/machine—the process—in the HMI program to be able to isolate the error.

The structuring of an automation program, in contrast, is guided more by the production sequence. Hence, the basic mechanisms for mapping structures of the HMI program to corresponding structures of the automation program can still be sorted and structured by means of specified or default rules, particularly user-editable rules.

Examples of such rules are given below:

1. Link all calls of representations (of buttons as well as fields and actions).

2. Remove loops and recursions.

3. Determine recurring sequences to expand the call structures.

4. Link all messages, actions, etc., that use the variables from a specific representation.

5. Determine an assignment and a sequence from the calls of a representation and the dependencies of the input fields, variables, messages, etc.

6 . . . .

The set of rules can be dynamically expanded and thereby adapted to the characteristics of the widest range of applications. The mechanism determines a preferred solution, which the user can adapt.

The following overview includes structures of the HMI program and the automatically generatable corresponding structures or sequences of the automation program:
a) Picture navigation, the link between a central representation with subordinate representations, in the HMI program is used to generate a rough structure of the automation program with a main program that corresponds to the central representation and a subroutine that corresponds, respectively, to one or each subordinate representation. Depending on the programming language generated by the generator, a display is converted, e.g., into a program or a subroutine, a module, a plan, a block or the like.

b) The sequence of the automation program, the interaction of the individual program elements, e.g., the call of a specific subroutine at a specific point, is derived from the picture navigation and thus the implicitly defined control sequences.
c) A limit value monitoring, for example, is generated from a message, or from a trigger for a message of the HMI program, particularly by means of a message configuration.
d) A limit value monitoring in the automation program is derived from limit values for display components in the HMI program, e.g., display components that react with a change in color.

e) Diagnostic monitoring in the automation program is generated from diagnostic images of the HMI program. The one or each diagnostic image of the HMI program includes a plurality of process data, which are presented to a user for diagnostic or monitoring purposes. These data can also be combined in the automation program for diagnostic monitoring.
f) Corresponding variables of the automation program are generated from variables of the HMI program. This promotes consistency between the HMI program and the automation program and enables a direct mutual data exchange, without requiring conversions, for example, and without the risk of conversion errors.
g) Simulation values for the automation program are generated from limit values and input blocks of the HMI program. Simulation values are used to test an automation program independently of the process to be controlled or monitored, such that at least an executable automation program is available at the time of commissioning and, ideally, commissioning is limited to fine adjustments.

An embodiment of the invention will now be described, by way of example, with reference to the drawing. Corresponding objects or elements are provided with the same reference number in all the figures, in which:

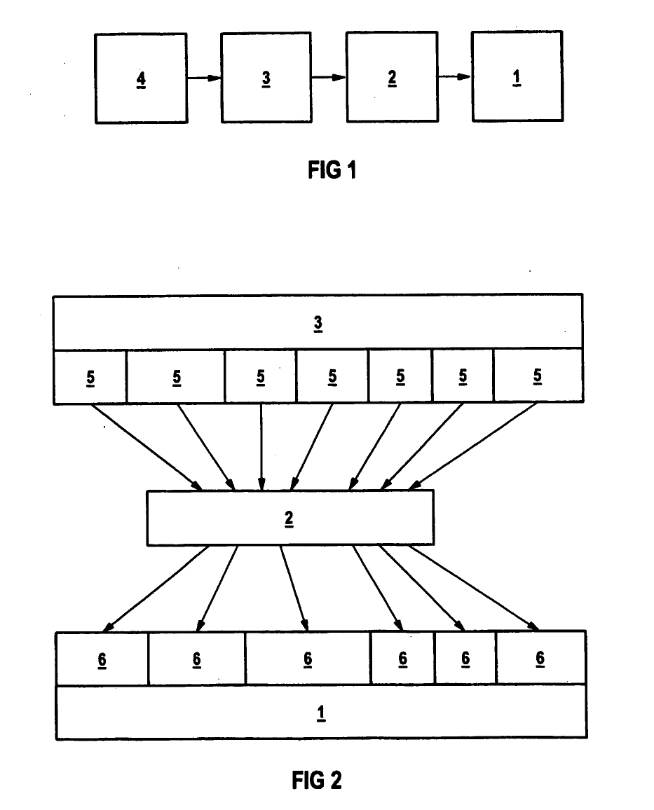

FIG. 1 illustrates a sequence of the automatic generation of an automation program,

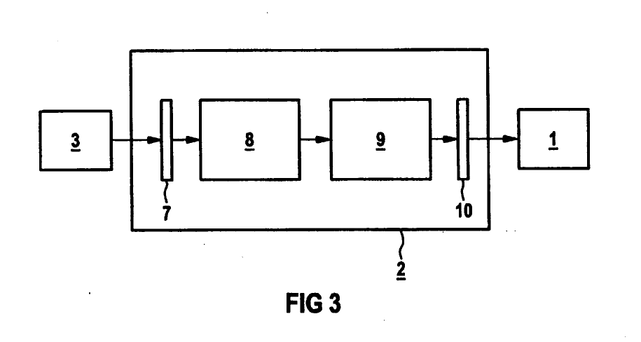

FIG. 2 shows details of the automatic generation of the automation program,

FIG. 3 is a block diagram of a generator for automatically generating the automation program, and

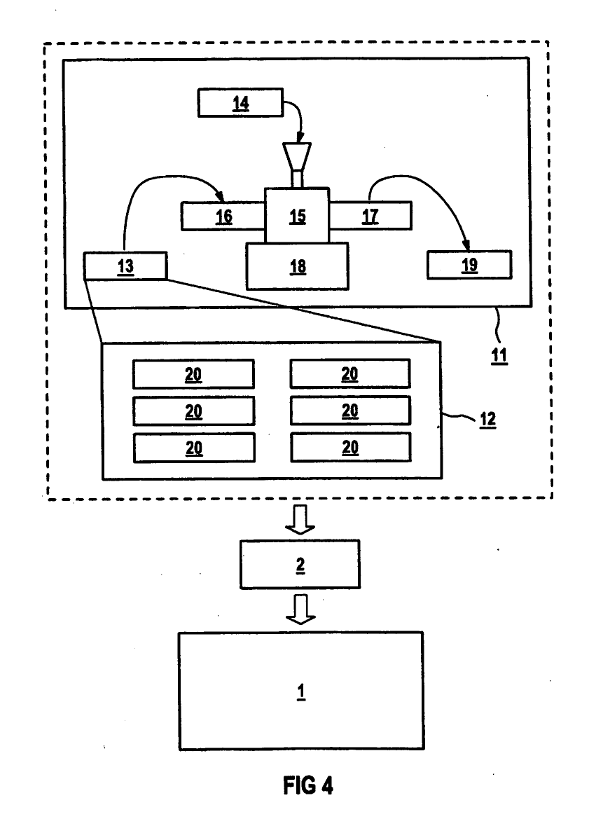

FIG. 4 shows a central and a subordinate representation of an HMI program.

FIG. 1 schematically shows a sequence of the automatic generation of an automation program 1. The automation program 1 is, for example, a program that is executed by a programmable logic controller or PLC (not depicted). The automation program 1 is therefore a PLC program 1. The terms automation program 1 and PLC program are hereinafter used synonymously.

To generate the automation program 1 a generator 2 is provided. The generator generates the automation program 1, or structures thereof, from a program for user guidance. Today, a program used, in particular, for graphic user guidance is referred to as an HMI program 3, which is short for human-machine interface program. The terms program for user guidance and HMI program 3 are therefore also used synonymously. The HMI program 3, in turn, is based on a planning program 4 with planning data, e.g., threshold values or limit values.

FIG. 2 shows details of the automatic generation of the automation program 1. Accordingly, structures and characteristics of the HMI program 3, such as navigation, control sequences, limit values, messages, diagnostics, variables, input blocks, etc., hereinafter jointly referred to as structures 5 or structural elements 5, are converted by the generator 2 into corresponding structures and characteristics of the automation program 1, such as program structure, sequential program, limit value monitoring, diagnostics, variables, simulation, etc., hereinafter jointly referred to as structures 6 or structural elements 6. To distinguish between them, structures 5 or structural elements 5 of the HMI program 3 are referred to as HMI structures 5 or HMI structural elements 5, and structures 6 or structural elements 6 of the automation program 1 are referred to as PLC structures 6 or PLC structural elements 6.

FIG. 3 shows a block diagram of the generator 2. Accordingly, the generator 2 includes an input interface 7, an evaluator 8, a converter 9 and an output interface 10.

The HMI program 3 is evaluated and converted by means of an intelligent algorithm distributed over the evaluator 8 and the converter 9. The core of this algorithm consists of a mechanism that systematically generates a PLC structure 6 or a PLC structural element 6 from an HMI structure 5 or an HMI structural element 5.

The input interface 7 is used to import the HMI program 3 or its structures 5. The evaluator 8 analyzes the HMI program or its structures. In the process, the data obtained are optionally linked according to specified or default rules, particularly user-editable rules, which are stored in a database (not depicted). At the output of the evaluator 8, the converter 9 links the results of the evaluator and generates PLC structures 6 or PLC structural elements 6. These are then transferred to the automation program 1 via the output interface 10.

FIG. 4 shows a central representation 11 and a subordinate representation 12 of an HMI program 3 (FIG. 1) as presented to a user of the HMI program 3 on a display device, e.g., a screen (not depicted). The central and the subordinate representation 11, 12 each include a plurality of picture components.

The central representation 11 is a first and a second picture component 13, 14 symbolizing, respectively, a first and a second raw material to be treated or processed in an automated process or a process to be automated. A third picture component 15 symbolizes a processing unit in the automated process or the process to be automated. A fourth and a fifth picture component 16, 17 each symbolize a first and second sorting device of the process. Finally, a sixth picture component 18 symbolizes a diagnostic and evaluation unit in the process, and a seventh picture component 19 symbolizes a packing unit in the process. The arrows indicate a material flow direction in the process.

Individual picture components are associated with a subordinate representation. In the representation shown in FIG. 4, the first picture component 13 is associated with the subordinate representation 12 to symbolize the first raw material. When a picture component associated with a subordinate representation is activated, e.g. by a pointing device, such as a mouse, the subordinate representation 12 is displayed.

The subordinate representation 12 includes input/output fields as picture components 20, which can be used to display a value of a variable of the HMI program 3 or can be modified corresponding to a user input. Specifically, the example depicted in FIG. 4 shows a picture component 20 to input or output a raw material type, a picture component 20 to input or output a number of units, a picture component 20 to input or output a speed, a picture component 20 to input or output a color, a picture component 20 to input or output a diameter and a picture component 20 to input or output a length.

The generator 2 uses the data thus contained in the central and in the subordinate representations 11, 12 to generate a structure for the automation program 1, e.g., depicted in the following pseudo code form. Structures for a main program (program process) and calls of subroutines associated with subordinate representations contained in the central representation are generated from the central representation 11, while a subroutine (procedure raw material1) with a variable declaration based on picture elements contained in the subordinate representation are generated from the subordinate representation 12.

Program process

| | |
|---|---|
| Call raw material1 | (raw material type, number of units, speed, |
| | color, diameter, length) |
| Call sorting | (x, y, z) |
| Call processing | (. . .) |
| Call . . . | |

Procedure raw material1

Var raw material type
Var number of units
Var . . .

Procedure . . .

Based on a default of the planning program 4 (FIG. 1), such as, e.g., “If the temperature exceeds 120 degrees during processing the coolant valve must be opened. The plant operator must be notified. This must be archived for review and documentation purposes.” and based on a portion of the HMI program 3 (FIG. 1), such as, e.g.,

Logic group bit 3 to bit 5

| | |
|---|---|
| Data word 5 bit 3: | “Warning, temperature is too high: % var |
| | temperature %” |
| Data word 5 bit 4: | “Coolant valve open” |
| Data word 5 bit 5: | “Coolant valve closed” |

the generator 2 can supplement the structures of the automation program 1 by program sequences, such as the ones shown below in pseudo code:

IF temperature > 120
THEN data word 5 bit 3: = 1

| | |
|---|---|
| Archive (temperature, time) | /* proposal |

[insert action for “coolant valve open”]
Data word 5 bit 4: = 1
IF [result is reached for

“coolant valve closed”]

THEN data word 5 bit 5: = 1

| | |
|---|---|
| Archive (temperature, time) | /* proposal |

ENDIF

ENDIF

The information “logic group bit 3 to bit 5” or the like must be contained in the HMI program 3 for the generator 2 to recognize the structure of the HMI program 3. The structure thus identified forms the frame for the program sequence to be generated. Message texts, such as “coolant valve open,” which are stored in the HMI program 3, can be transferred to the program sequence in the form of comments. These comments provide the programmer in charge of completing the automation program 1 with information on the respective program instructions to be used.

Thus, the invention can be summarized as follows:

A method is provided for generating an automation program 1 from an HMI program 3 using a generator 2. The generator 2 recognizes structures of the HMI program 3 and converts them into structures of the automation program 1. This takes into account the recognition that it is more efficient to generate an automation program (PLC program) on the basis of HMI data and, optionally, planning data than to first create the automation program and then the HMI program, as is the practice today. In addition, today's HMI programs already contain a major part of the data and their mutual dependencies required for an automation program. This makes it possible to “reverse” the planning sequence. Apart from the obvious savings potential, the modified sequence comes closer to the way the respective user would intuitively proceed. In addition, an increasing number of program parts are available in solution-specific standard libraries or industry libraries and are no longer programmed but just used. Finally graphic user guidance is becoming ever more convenient, e.g., with respect to graphics, dynamics, networking, etc.

1-10. (canceled)

11. A method for generating an automation program from a human machine interface (HMI) program using a generator, the method comprising:
recognizing, by the generator, structures of the HMI program; and
converting the recognized structures into structures of the automation program.

12. The method as claimed in claim 11, wherein the HMI program is based on a planning program and wherein the generator utilizes planning data of the planning program in generating the automation program.

13. The method as claimed in claim 12, wherein the HMI program comprises a navigation component with a central representation and at least one subordinate representation, and wherein the generator generates a main program based on the central representation and, for each of the at least one subordinate representation, the generator generates a respective subroutine of the automation program.

14. The method as claimed in claim 13, wherein:
each representation of the central representation and the at least one subordinate representation comprises a plurality of picture components,
individual picture components from the plurality of picture components are associated with a representation subordinate to a representation of the respective individual picture component, and
for each picture component in a representation that is associated with a subordinate representation, the generator generates a call of a subroutine corresponding to the subordinate representation.

15. The method as claimed in claim 14, wherein:
the individual picture components are provided as input or output components for inputting or outputting process data, and
the generator generates a parameter list for a call of a respective subroutine based on input or output components comprised in a representation.

16. The method as claimed in claim 15, wherein the generator expands the respective parameter list with respect to the input and output components comprised in the subordinate representations.

17. The method as claimed in claim 11, wherein the HMI program comprises a navigation component with a central representation and at least one subordinate representation, and wherein the generator generates a main program based on the central representation and, for each of the at least one subordinate representation, the generator generates a respective subroutine of the automation program.

18. The method as claimed in claim 17, wherein:
each representation of the central representation and the at least one subordinate representation comprises a plurality of picture components,
individual picture components from the plurality of picture components are associated with a representation subordinate to a representation of the respective individual picture component, and
for each picture component in a representation that is associated with a subordinate representation, the generator generates a call of a subroutine corresponding to the subordinate representation.

19. The method as claimed in claim 18, wherein:
the individual picture components are provided as input or output components for inputting or outputting process data, and
the generator generates a parameter list for a call of a respective subroutine based on input or output components comprised in a representation.

20. The method as claimed in claim 19, wherein the generator expands the respective parameter list with respect to the input and output components comprised in the subordinate representations.

21. The method as claimed in claim 1, wherein the generator converts a display process data of the HMI program, based on at least one condition, into a program sequence to check the condition.

22. The method as claimed in claim 21, wherein the generator generates the program sequence as a component of the subroutine corresponding to the representation that comprises the display process data.

23. The method as claimed in claim 22, wherein message texts of the HMI program are transferred to the program sequence as comment lines.

24. The method as claimed in claim 21, wherein message texts of the HMI program are transferred to the program sequence as comment lines.

25. The method as claimed in claim 1, wherein the generator determines a sequence of calls of subroutines in the automation program based on user-editable rules.

26. A system generating an automation program from a human machine interface (HMI) program comprising:
a generator recognizing structures of the HMI program and converting the recognized structures into structures of the automation program,
wherein the generator comprises:
an input interface importing the structures of the HMI program into the generator,
an evaluator receiving the structures of the HMI program from the input interface and analyzing the structures,
a converter receiving analyzed structures from the evaluator and converting the analyzed structures into the structures of the automation program, and
an output interface transferring the converted structures to the automation program.
